(19) United States
(12) Patent Application Publication
(10) Pub. No.: US 2025/0236039 A1
(43) Pub. Date: Jul. 24, 2025

(54) Palm and Finger Protector Knife Attachment Device

(71) Applicant: Sunil Warrier, Lake Forest, CA (US)

(72) Inventor: Sunil Warrier, Lake Forest, CA (US)

(21) Appl. No.: 18/950,485

(22) Filed: Nov. 18, 2024

Related U.S. Application Data
(60) Provisional application No. 63/622,250, filed on Jan. 18, 2024.

(51) Int. Cl. B26B 29/02

(52) U.S. Cl. CPC B26B 29/02

(57) ABSTRACT

The subject matter disclosed and claimed herein, in one embodiment thereof, comprises a palm and finger protector knife attachment device. The device is a knife attachment that provides users with a protective device for knives capable of preventing injury to the fingers and palm while cutting, chopping, or dicing food. The palm and finger protector knife attachment device covers both sides of the knife via a magnet, keeping the guard in place while applying pressure to the knife. Thus, once the device is attached to a knife, users can apply pressure to the device rather than the knife itself to cut through food items.

### CROSS-REFERENCE TO RELATED APPLICATION

The present application claims priority to, and the benefit of, U.S. Provisional Application No. 63/622,250, which was filed on Jan. 18, 2024, and is incorporated herein by reference in its entirety.

### FIELD OF THE INVENTION

The present invention relates generally to the field of hand protecting knife attachment devices. More specifically, the present invention relates to knife attachment that protects users' fingers when cutting, chopping, or dicing food articles Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in knife attachment devices. Generally, it is important to use a sharp knife while cutting food and different ingredients in the kitchen. However, using a sharp knife can be very dangerous. The sharper a knife is, the greater the chances there are for injury due to slipping. A person may find their knife slipping and then end up accidentally cutting themselves, causing injury and pain. Without a way to protect the fingers while cutting, individuals may suffer serious injury.

Accordingly, there is a demand for an improved palm and finger protector knife attachment device that prevents self-injury. More particularly, there is a demand for a palm and finger protector knife attachment device that provides users with a protective device for use with sharp knives.

Therefore, there exists a long felt need in the art for a palm and finger protector knife attachment device that provides users with a protective device for knives capable of preventing injury to the fingers and palm while cutting, chopping, or dicing food. There is also a long felt need in the art for a palm and finger protector knife attachment device that covers both sides of the knife via a magnet to keep the guard in place while applying pressure to the knife. Further, there is a long felt need in the art for a palm and finger protector knife attachment device that features a textured surface that enables users to maintain a stable, secure grip on the knife while they are cutting and chopping. Finally, there is a long felt need in the art for a palm and finger protector knife attachment device that maintains optimal pressure on the knife for quickly slicing through items without interfering with standard knife operation.

The subject matter disclosed and claimed herein, in one embodiment thereof, comprises a palm and finger protector knife attachment device. The device is a knife attachment that provides users with a protective device for knives capable of preventing injury to the fingers and palm while cutting, chopping, or dicing food. The palm and finger protector knife attachment device covers both sides of the knife via a magnet, keeping the guard in place while applying pressure to the knife. The device features a textured surface that provides a stable, secure grip. The device maintains optimal pressure on the knife for quick slicing without interfering with standard knife operation. The palm and finger protector knife attachment device comprises a guard that covers both sides of the knife with a strong magnet to keep the guard secure in place. The guard has a textured surface for easy grip, even when wet. The device is washable and has an exterior magnet for storing it in a desired area. The device provides flexibility, improves safety, and can be used with multiple sizes of knives. Thus, once the device is attached to a knife, users can apply pressure to the device rather than the knife itself to cut through food items. Accordingly, the palm and fingers are kept safe via the barrier formed between the attachment and the knife.

In this manner, the palm and finger protector knife attachment device of the present invention accomplishes all of the forgoing objectives and provides users with a device that enables for a safer cutting, chopping, or dicing experience. The device prevents injury to the fingers and palm.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a palm and finger protector knife attachment device. The device is a knife attachment that provides users with a protective device for knives capable of preventing injury to the fingers and palm while cutting, chopping, or dicing food. The palm and finger protector knife attachment device covers both sides of the knife via a magnet, keeping the guard in place while applying pressure to the knife. Thus, once the device is attached to a knife, users can apply pressure to the device rather than the knife itself to cut through food items.

In one embodiment, the palm and finger protector knife attachment device comprises a body component. The body component is typically configured in a rectangular (i.e., rectilinear) shape but can be configured in any suitable shape as is known in the art. Typically, the body component comprises a slot, a knife retaining magnet, a storage magnet, a curved surface, and a textured surface.

In one embodiment, the body component of the device comprises a knife retaining magnet within the slot. The knife retaining magnet is a strong magnet that reversibly secures the blade of a knife within the slot of the device. This design also enables for adjustment of the device up and down the shaft of the blade to suit user needs or preferences.

In one embodiment, the body component also comprises a storage magnet, a curved surface, and a textured surface. The storage magnet is located on the side of the body component and can be used to store the device in a desired area. The curved surface is generally located on the bottom distal end of the device, designed to be facing the tip of a knife. This curved surface enables for rocking movement of the knife without interference. The textured surface is generally located on the top of the body component, where the user will place their hand in use. The textured surface provides for a secure grip, even when wet.

In one embodiment, the palm and finger protector knife attachment device in accordance with the present invention can be produced in various colors, designs, patterns, etc., and feature logos, emblems and or designs, such as a distributor requests and/or a user desires.

In one embodiment, the palm and finger protector knife attachment device is manufactured of wood or a high-density polyethylene (HDPE), or any other suitable materials as is known in the art. Any number of different types of materials can be used to make the palm and finger protector knife attachment device including but not limited to plastics, nylon, etc.

In use, the user secures the device over the top of a knife via the knife retaining magnet found in the slot of the body component. The user then places one hand on the handle of the knife and the other on the textured surface of the device. The user can then begin cutting food by applying downward pressure to the device. Thus, the palm and finger protector knife attachment device 100 makes cutting, chopping, or dicing food much safer than ordinary methods.

It will also be appreciated that there are a number of additional add-on features that can be incorporated into the device and moreover, the palm and finger protector knife attachment device can take many different forms as is known in the art.

In yet another embodiment, the palm and finger protector knife attachment device comprises a plurality of indicia.

In yet another embodiment, a method of conveniently cutting, chopping, or dicing food while utilizing the palm and finger protector knife attachment device is disclosed. The method includes the steps of providing a palm and finger protector knife attachment device comprising a body component featuring a slot, a knife retaining magnet, a storage magnet, a curved surface, and a textured surface. The method also comprises securing the device over the top or upper edge of a knife blade via the knife retaining magnet found in the slot of the body component. Further, the method comprises placing one hand on the knife handle and the other on the textured surface of the device. Next, the method comprises cutting food by applying downward pressure to the device. Finally, the method comprises utilizing the device while cutting, chopping, or dicing.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the palm and finger protector knife attachment device of the present invention being used to chop vegetables in accordance with the disclosed architecture;

FIG. 2 illustrates another perspective view of one embodiment of the palm and finger protector knife attachment device of the present invention being used to chop vegetables in accordance with the disclosed architecture;

FIG. 3 illustrates a perspective view of a user using a knife without the palm and finger protector knife attachment device of the present invention in accordance with the disclosed architecture;

FIG. 4 illustrates a perspective, standalone view of one embodiment of the palm and finger protector knife attachment device of the present invention in accordance with the disclosed architecture;

FIG. 5 illustrates detailed diagrams of the palm and finger protector knife attachment device of the present invention from multiple perspectives; and

FIG. 6 illustrates a flowchart showing the method of conveniently cutting, chopping, or dicing food while utilizing the palm and finger protector knife attachment device in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for a palm and finger protector knife attachment device that provides users with a protective device for knives capable of preventing injury to the fingers and palm while cutting, chopping, or dicing food. There is also a long felt need in the art for a palm and finger protector knife attachment device that covers both sides of the knife via a magnet to keep the guard in place while applying pressure to the knife. Further, there is a long felt need in the art for a palm and finger protector knife attachment device that features a textured surface that enables users to maintain a stable, secure grip on the knife while they are cutting and chopping. Finally, there is a long felt need in the art for a palm and finger protector knife attachment device that maintains optimal pressure on the knife for quickly slicing through items without interfering with standard knife operation.

The present invention, in one exemplary embodiment, is a novel palm and finger protector knife attachment device for safely cutting, chopping, or dicing items while using a sharp knife. The palm and finger protector knife attachment device comprises a body component that is configured in a rectangular (i.e., rectilinear) shape. The bottom of the body component comprises a slot with a strong knife retaining magnet in which the top or upper edge of a knife blade is inserted. Thus, once the device is secured to a knife, a user can place downward pressure on the device to cut, chop, or slice without worry of self-injury. This device could also cater to those with joint pain, peripheral neuropathy, and other muscular/joint issues. This device could also cater to those with joint pain, peripheral neuropathy, and other muscular/joint issues. The present invention also includes a novel method of conveniently cutting, chopping, or dicing food while utilizing the palm and finger protector knife attachment device. The method includes the steps of providing a palm and finger protector knife attachment device comprising a body component featuring a slot, a knife retaining magnet, a storage magnet, a curved surface, and a textured surface. The method also comprises securing the device over the top or upper edge of a knife blade via the knife retaining magnet found in the slot of the body component. Further, the method comprises placing one hand on the knife handle and the other on the textured surface of the device. Next, the method comprises cutting food by applying downward pressure to the device. Finally, the method comprises utilizing the device while cutting, chopping, or dicing.

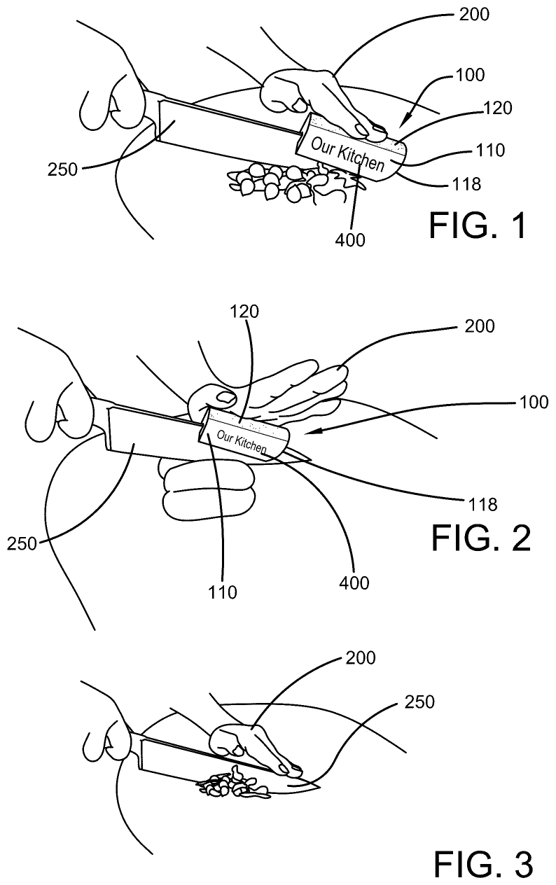

Referring initially to the drawings, FIG. 1 illustrates a perspective view of one embodiment of the palm and finger protector knife attachment device 100 of the present invention being used to chop vegetables. In the present embodiment, the palm and finger protector knife attachment device 100 is novel palm and finger protector knife attachment device 100 for safely cutting, chopping, or dicing items while using a sharp knife 250. The palm and finger protector knife attachment device 100 comprises a body component 110 that is configured in a rectangular (i.e., rectilinear) shape. The bottom of the body component 110 comprises a slot 112 with a strong knife retaining magnet 114 in which the top or upper edge of a knife blade is inserted. Thus, once the device 100 is secured to a knife 250, a user 200 can place downward pressure on the device 100 to cut, chop, or slice without worry of self-injury.

Generally, the palm and finger protector knife attachment device 100 of the present invention assists any setting in which cutting, chopping, or dicing with a knife is performed. The palm and finger protector knife attachment device 100 secures easily to the blade of a knife 250 and protects the user's hands while cutting. The device 100 features a textured surface 120 that enables users to maintain a stable, secure grip. The device 100 features a curved surface 118 on the bottom distal end that enables for rocking movement of the knife 250 without interference. The device 100 is portable in that it is configured to be easily carried by a person and is sized so as to be used with any standard kitchen knife 250.

As shown in FIGS. 1 and 2, in use, the user 200 secures the device 100 over the top of a knife 250 via the knife retaining magnet 114 found in the slot 112 of the body component 110. The user 200 then places one hand on the handle of the knife 250 and the other on the textured top surface or upper side 120 of the device 100. The textured top surface 120 is curvilinear. The user 200 can then begin cutting food by applying downward pressure to the device 100. Thus, the palm and finger protector knife attachment device 100 makes cutting, chopping, or dicing food much safer than ordinary methods.

The palm and finger protector knife attachment device 100 in accordance with the present invention can be produced in various colors, designs, patterns, etc., and feature logos, emblems and or designs, such as a distributor requests and/or a user 200 desires.

Shown in FIG. 3 is a knife 250 being used without the device 100. With no protection from accidental cuts, a sharp knife may slip and cause injury and pain. Without a way to protect the fingers and palm of a user 200, serious injury may occur.

In one embodiment, the palm and finger protector knife attachment device 100 is manufactured of wood or a high-density polyethylene (HDPE), or any other suitable materials as is known in the art. Any number of different types of materials can be used to make the palm and finger protector knife attachment device 100 including but not limited to nylon, heat-sealable plastic or polymers, such as polypropylene or acrylonitrile-butadiene-styrene (ABS), or any other suitable material as is known in the art, such as but not limited to, acrylic, polycarbonate, polyethylene, polyethylene terephthalate, polyvinyl chloride, polystyrene, etc. Generally, the palm and finger protector knife attachment device 100 is also manufactured from a material that is water resistant or waterproof, or the body component 110 comprises a coating that is water resistant or waterproof.

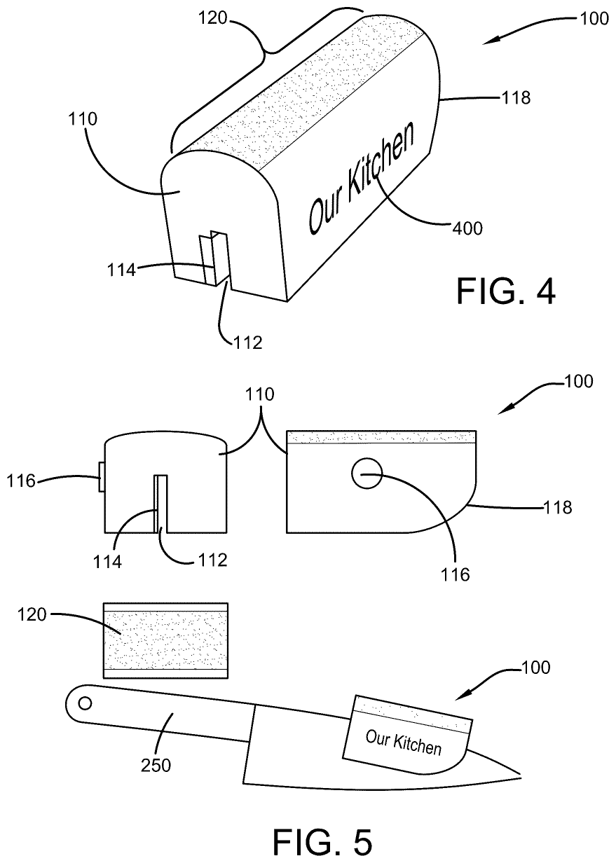

In yet another embodiment, and as shown in FIG. 4, the palm and finger protector knife attachment device 100 comprises a plurality of indicia 400. The body component 110 of the device 100 may include advertising, a trademark, or other letters, designs, or characters, printed, painted, stamped, or integrated into the body component 110, or any other indicia 400 as is known in the art. Specifically, any suitable indicia 400 as is known in the art can be included, such as but not limited to, patterns, logos, emblems, images, symbols, designs, letters, words, characters, animals, advertisements, brands, etc., that may or may not be cooking, knife, or brand related.

Shown in FIG. 5 is a detailed diagram of the device 100 from multiple perspectives. The front view illustrates the slot 112 and knife retaining magnet 114. The side view illustrates the storage magnet 116 and curved surface 118. The top view illustrates the textured surface 120, and the final view at the bottom of the figure shows the adjustability of the device 100 along the blade of a knife 250.

It will also be appreciated that there are a number of additional add-on features that can be incorporated into the device 100 and moreover, the palm and finger protector knife attachment device 100 can take many different forms as is known in the art.

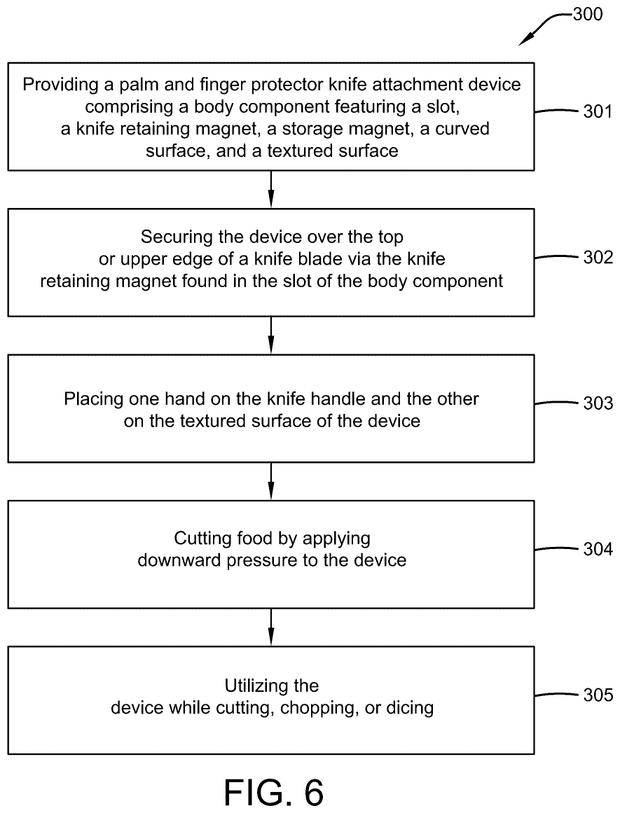

FIG. 6 illustrates a flowchart of the method 300 of conveniently cutting, chopping, or dicing food while utilizing the palm and finger protector knife attachment device. The method includes the steps of at 301, providing a palm and finger protector knife attachment device comprising a body component featuring a slot, a knife retaining magnet, a storage magnet, a curved surface, and a textured surface. The method also comprises at 302, securing the device over the top or upper edge of a knife blade via the knife retaining magnet found in the slot of the body component. Further, the method comprises at 303, placing one hand on the knife handle and the other on the textured surface of the device. Next, the method comprises at 304, cutting food by applying downward pressure to the device. Finally, the method comprises at 305, utilizing the device while cutting, chopping, or dicing.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “palm and finger protector knife attachment device”, “knife attachment device”, “hand protection device”, and “device” are interchangeable and refer to the palm and finger protector knife attachment device 100 of the present invention.

Notwithstanding the forgoing, the palm and finger protector knife attachment device 100 of the present invention can be of any suitable size and configuration as is known in the art without affecting the overall concept of the invention, provided that it accomplishes the above stated objectives. One of ordinary skill in the art will appreciate that the palm and finger protector knife attachment device 100 as shown in FIGS. 1-5 is for illustrative purposes only, and that many other sizes and shapes of the palm and finger protector knife attachment device 100 are well within the scope of the present disclosure. Although the dimensions of the palm and finger protector knife attachment device 100 are important design parameters for user convenience, the palm and finger protector knife attachment device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A palm and finger protector knife attachment device comprising:
a knife;
an attachment device;
a body component;
a slot; and
a magnet;
further wherein said slot is a retaining slot for retaining a portion of an upper edge of said knife for safely cutting an item with said knife.

2. The palm and finger protector knife attachment device of claim 1, wherein said body component having a rectilinear shape.

3. The palm and finger protector knife attachment device of claim 1, wherein said body component having a bottom side;
wherein said slot extending from said bottom side upward into said body component; and
further wherein said bottom side is curvilinear.

4. The palm and finger protector knife attachment device of claim 3, wherein said slot having said magnet for securing said body component to said portion of said upper edge of said knife.

5. The palm and finger protector knife attachment device of claim 4, wherein said slot centered in said bottom slot.

6. The palm and finger protector knife attachment device of claim 5, wherein said body component having an upper side; and
further wherein said upper side is curvilinear.

7. The palm and finger protector knife attachment device of claim 6, wherein said upper side having a textured top surface.

8. The palm and finger protector knife attachment device of claim 7, wherein said body component having a material selected from the group consisting of a wood, a high-density polyethylene (HDPE), a nylon, a heat-sealable polymer, a polypropylene, and an acrylonitrile-butadiene-styrene (ABS).

9. A palm and finger protector knife attachment device comprising:
a knife;
an attachment device;
a body component;
a slot; and
a magnet;
wherein said body component having a bottom side;
wherein said slot extending from said bottom side upward into said body component;
wherein said slot is a retaining slot for retaining a portion of an upper edge of said knife; and
further wherein said slot having said magnet for securing said body component to said portion of said upper edge of said knife.

10. The palm and finger protector knife attachment device of claim 9, wherein said body component having a rectilinear shape.

11. The palm and finger protector knife attachment device of claim 9, wherein said slot centered in said bottom slot.

12. The palm and finger protector knife attachment device of claim 9, wherein said body component having an upper side; and
further wherein said upper side is curvilinear.

13. The palm and finger protector knife attachment device of claim 12, wherein said upper side having a textured top surface for placing a user's palm and fingers thereon.

14. The palm and finger protector knife attachment device of claim 9, wherein said body component having a material selected from the group consisting of a wood, a high-density polyethylene (HDPE), a nylon, a heat-sealable polymer, a polypropylene, and an acrylonitrile-butadiene-styrene (ABS).

15. A palm and finger protector knife attachment device comprising:
a knife;
an attachment device;
a body component; and
a slot;
wherein said body component having a bottom side;
wherein said slot extending from said bottom side upward into said body component;
wherein said slot is a retaining slot for retaining a portion of an upper edge of said knife for safely cutting an item with said knife;
wherein said body component having an upper side; and
further wherein said upper side having a textured top surface for placing a user's palm and fingers thereon.

16. The palm and finger protector knife attachment device of claim 15 further comprising a magnet, wherein said slot having said magnet for securing said body component to said portion of said upper edge of said knife.

17. The palm and finger protector knife attachment device of claim 16, wherein said body component having a rectilinear shape.

18. The palm and finger protector knife attachment device of claim 17, wherein said slot centered in said bottom slot.

19. The palm and finger protector knife attachment device of claim 18, wherein said upper side is curvilinear.

20. The palm and finger protector knife attachment device of claim 19, wherein said body component having a material selected from the group consisting of a wood, a high-density polyethylene (HDPE), a nylon, a heat-sealable polymer, a polypropylene, and an acrylonitrile-butadiene-styrene (ABS).
